(19) United States
(12) Patent Application Publication
(10) Pub. No.: US 2012/0077013 A1
(43) Pub. Date: Mar. 29, 2012

(54) COMPOSITE ELEMENT MADE FROM A PREFORM

(75) Inventors: Steffen Kunze, Vagen (DE); Hermann Spanner, Bichl (DE); Thomas Unterhauser, Seyboldsdorf (DE); Christian Weimer, Munchen (DE)

(73) Assignee: EUROCOPTER DEUTSCHLAND GMBH, Donauworth (DE)

(21) Appl. No.: 13/212,312

(22) Filed: Aug. 18, 2011

(30) Foreign Application Priority Data
Sep. 23, 2010 (EP) 10 400046.8

(51) Int. Cl. B32B 5/00; B29C 45/14

(52) U.S. Cl. 428/292.1; 264/257; 264/238

(57) ABSTRACT

A composite element made from a preform of fiber-reinforced plastic material arranged around a core with a multi-layer thermoplastic foil between the preform and the core and a method for fabrication of such a composite element. At least one of the layers of said multi-layer thermoplastic foil has a different melting temperature from the melting temperature of at least one of the other layers.

### CROSS REFERENCE TO RELATED APPLICATIONS

This application claims the benefit of EP 10 400046.8 filed on Sep. 23, 2010, the disclosure of which is incorporated in its entirety by reference herein.

### BACKGROUND OF THE INVENTION

(1) Field of the Invention

The invention relates to a composite element made from a preform of fiber-reinforced plastic material with the features of the preamble of claim 1 and a method of fabrication of such a composite element with the features of the preamble of claim 11.

(2) Description of Related Art

Composite elements in varying geometrical shapes, such as hollow beams, are made from fiber-reinforced plastic material. Complex shapes of such composite elements can be created by applying the fiber-reinforced plastic material around suitably shaped cores and curing the fiber reinforced plastic material. The core may be removed from the fiber reinforced plastic material after curing.

The document EP 1795332 A1 discloses a hollow core composite assembly including a hollow core base having an open core surface, a solid film applied to the hollow core base and an adhesive layer positioned between the solid film and the open core surface. The resultant hollow core composite assembly (10) is cured to provide a structure suitable for use within a liquid molding process.

The document DE 20 2008 012 572 U1 discloses the production of a composite sandwich by infusion methods, comprising a central heart including a panel of structure of honeycomb.

The document WO 02074469 A2 discloses a molded composite structure and a method of manufacturing a molded composite structure. In one embodiment, an aircraft wing paned and a method for manufacturing an aircraft wing panel are disclosed.

The document DE 10 2005 011 930 (B3) discloses the production of sealed water-soluble moulding cores by 1. filling a mould with water-soluble moulding material; 2. curing it to produce an under-sized core; 3. vacuum packing the core in a film; and 4. sealing the package. A reinforcing fiber material may be applied onto the package, said reinforcing fiber material being subsequently impregnated with curable resin and said resin being cured to form a solid, stable composite element with the film serving as a barrier between the core and the resin to prevent the resin from infiltrating into the core. Technical disadvantages still remain with respect to handling and characteristics of the composite elements, such problems being exposed for example in WO 02/057527 A1 directed to a method of producing a non-crimp fabric. One option for improved handling of composite elements from fiber-reinforced plastic material is to provide the fiber-reinforced plastic material as a preform, i.e. a preshaped fibrous reinforcement material that has been prepared for convenient handling and control of uniformity during the mold loading process. A binder is used for the preparation of a preform. Binder remaining in the preform during curing may have negative consequences with regard to the coherence of the resulting composite elements as the binder is not compatible with the infusion resin. Nowadays serial production does not provide any technology to mount such preforms onto any core materials. All the preforms have to be arranged manually in a RTM-mould implying high risks as to the production. Technological and economical advantages of a preform mounted by way of a supplemental intermediate adhesive fleece to a not dissoluble foam plastic core could be demonstrated. Such a preform mounted by way of an intermediate adhesive fleece to a core does not exclude the possibility of penetration of resin into the core when the reinforcing fiber material of the preform is subsequently impregnated with said curable resin to form the composite element.

### SUMMARY OF THE INVENTION

It is an object of the invention to provide for composite elements made from a preform of fiber-reinforced plastic material without the disadvantages of the state of the art and to provide a method of fabrication for such a composite element from a preform.

The solution is provided with composite elements made from a preform of fiber-reinforced plastic material with the features of claim 1 and with a method of fabrication of such a composite element from a preform with the features of claim 11.

According to the invention a composite element is made by curing of a preform of fiber-reinforced plastic material said preform being arranged around a core with a foil between the core and the fiber-reinforced plastic material. The foil is a multi-layer thermoplastic foil. At least one of the layers of said multi-layer thermoplastic foil has a melting temperature different from the melting temperatures of the other layers. An inner layer of said multi-layer thermoplastic foil may preferably have a higher melting temperature than an outer layer of said multi-layer thermoplastic foil. The multi-layer thermoplastic foil of the inventive composite element allows the combination of the step of mounting the preform to the core with the preceding step of stabilisation of the preform. At least one layer of said multi-layer thermoplastic foil can serve due to its melting temperature as a barrier towards the core and at least one of the outer layers of said multi-layer thermoplastic foil can serve due to its lower melting temperature as an adhesion element for fixation of the preform to the core and stabilisation. Thus the inventive arrangement of said multi-layer thermoplastic foil with an outer adhesive layer around the core allows improved handling of the preform and better draping of the core during the step of mounting the preform to the core and thus results in cost efficiency, reduction of production time and working steps. Less or no binder is necessary for the preform. Additionally the multi-layer thermoplastic foil with a barrier layer avoids contamination of the core with the resin used for curing of the fiber-reinforced plastic material such feature being particularly advantageous for open-cell cores.

According to a preferred embodiment of the invention said multi-layer thermoplastic foil is provided with two layers and a dissoluble core. One outer layer of said multi-layer thermoplastic foil serves as an adhesion element for improved handling of the preform during the step of mounting the preform to the core while the inner barrier layer avoids penetration of resin towards the core during curing of the fiber-reinforced plastic material of the preform. The core is dissoluble and can be removed after curing of the fiber-reinforced plastic material of the preform for low weight of the inventive composite element.

According to a further preferred embodiment of the invention said outer layer of said multi-layer thermoplastic foil with a contact surface to the preform of fiber-reinforced plastic material has a lower melting temperature than the inner layer with a contact surface to the core for advantageous provision of the adhesive characteristic to said outer layer and the isolating characteristic to said inner layer.

According to a further preferred embodiment of the invention the multi-layer thermoplastic foil is provided with at least three layers and a core not being dissoluble. A first outer layer of said multi-layer thermoplastic foil with a contact surface to the preform of fiber-reinforced plastic material has a lower melting temperature than an intermediate layer between said first and a second outer layer of said multi-layer thermoplastic foil with as well a lower melting temperature and a contact surface to the core for advantageous provision of adhesion between said first outer layer and the preform of fiber-reinforced plastic material and adhesion between said second outer layer and the core thus providing for the transfer of shear forces/stresses from the preform via the multi-layer thermoplastic foil to the core. The isolating characteristic against any leaking of resin towards the core is provided by said intermediate layer between said first and said second outer layer of said multi-layer thermoplastic foil.

According to a further preferred embodiment of the invention said multi-layer thermoplastic foil is co-extruded with the inherent combination of barrier and adhesion characteristics for specific layers.

According to a preferred embodiment of the invention a method of making a composite element from a preform of fiber-reinforced plastic material is provided by the following steps: preparing the preform to a suitable shape by using a binder powder and/or by stitching its fabric, wrapping the co-extruded multi-layer thermoplastic foil around the core with the outer layer with adhesive properties facing away from the core and the inner layer with a barrier functionality adjacent to the core, attaching the preform of fiber-reinforced plastic material to the outer layer of the multi-layer thermoplastic foil, applying resin to the preform and curing the composite element in a mould, and removing the dissoluble core by scavenging inside the composite element. Removing the dissoluble core from inside the composite element results in a light weight composite element with particular advantages for appliances in aircrafts. The inventive method allows improved handling of the preform, better draping of the core during the step of mounting the preform to the core and thus results in cost efficiency, reduction of production time and working steps.

According to a further preferred method of the invention wrapping of the co-extruded multi-layer thermoplastic foil around the core may be effected with the first outer layer with adhesive properties facing away from the core, the second outer layer with adhesive properties being adjacent to the core and the inner, intermediate layer with a barrier functionality being between the first outer layer and the second outer layer. The core is maintained inside the composite element after cure and the second outer layer with adhesive properties adjacent to the core provides for introduction of any shear forces/stresses from the preform via the multi-layer thermoplastic foil into the core for improved load bearing characteristics of the composite element while preserving all a. m. advantages of the inventive method.

### BRIEF DESCRIPTION OF THE DRAWINGS

A preferred embodiment of the invention is presented by reference to the attached drawing.

FIG. 1 shows a schematic view of a cross-section of a composite element according to the invention.

### DETAILED DESCRIPTION OF THE PREFERRED EMBODIMENTS

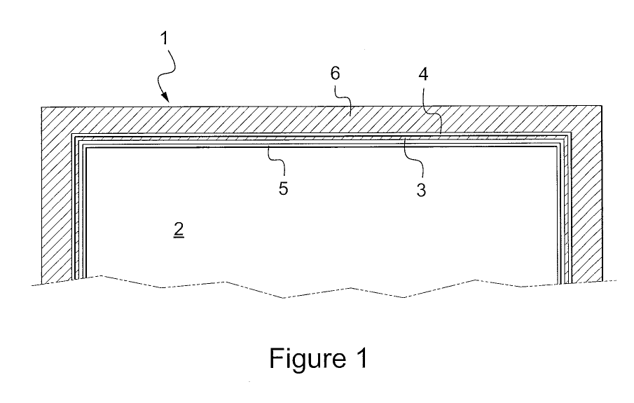

FIG. 1: An essentially rectangular composite element 6 is built from a preform 1 of fiber-reinforced plastic material. The preform 1 is shaped in a two- or three-dimensional form and is arranged around a correspondingly shaped dissoluble core 2 of the open-cell type. For the preparation of preform 1 reference is made to the teaching of WO 02/057527 A1 said teaching being introduced into the present application.

A multi-layer thermoplastic foil 3 is arranged between the preform 1 and the core 2.

An outer layer 4 of said multi-layer thermoplastic foil 3 is provided with a low viscosity, adhesive contact surface towards the preform 1 of fiber-reinforced plastic material due to a lower melting temperature than the melting temperature of the inner layer 5 with a contact surface towards the core and a barrier functionality for any resin penetrating during curing from the fiber-reinforced plastic material of the preform 1 through the outer layer 4.

An alternative multi-layer thermoplastic foil (not shown) between the preform and the core is provided with at least three layers: a first outer layer, a second outer layer and an intermediate layer between the first outer layer and the second outer layer. The first outer layer is provided with an adhesive contact surface towards the preform of fiber-reinforced plastic material due to a lower melting temperature than the melting temperature of the intermediate layer with a barrier functionality for any resin penetrating during curing from the fiber-reinforced plastic material of the preform through the first outer layer. The second outer layer of said multi-layer thermoplastic foil has as well a lower melting temperature than the melting temperature of the intermediate layer and a contact surface to the core for provision of adhesion between said second outer layer and said core.

Method of Making a Composite Element from a Preform

The preform 1 of fiber-reinforced plastic material is prepared to an essentially rectangular shape by using a binder powder and/or by stitching its fabric.

The multi-layer thermoplastic foil 3 is made from co-extrusion. The multi-layer thermoplastic foil 3 is wrapped around the essentially rectangular core 2 with the outer layer 4 with adhesive properties facing away from the core 2 and the inner layer 5 with a barrier functionality adjacent to the core 2. The multi-layer thermoplastic foil 3 is shrink wrapped to the core 2.

The preform 1 of fiber-reinforced plastic material is attached to the outer layer 4 of the multi-layer thermoplastic foil 3. Resin is applied to the preform 1 and cured to the composite element 6 in a mould.

Subsequently the dissoluble core 2 is removed by scavenging inside the composite element 6.

Alternatively the multi-layer thermoplastic foil may be wrapped, particularly shrink wrapped, around the essentially rectangular core with the first outer layer with adhesive properties facing away from the core, the second outer layer with adhesive properties adjacent to the core and an intermediate layer with a barrier functionality between the first outer layer and the second outer layer. The core is maintained inside the composite element.

What is claimed is:

1. A composite element made from a preform of fiber-reinforced plastic material arranged around a core with a foil between the preform and the core, wherein the foil is a multi-layer thermoplastic foil with at least one of the layers of said multi-layer thermoplastic foil having a different melting temperature from the melting temperature of at least one of the other layers.

2. A composite element according to claim 1, wherein the multi-layer thermoplastic foil is provided with two layers and in that the core is dissoluble.

3. A composite element according to claim 2, wherein an outer layer of said multi-layer thermoplastic foil has a lower melting temperature than an inner layer.

4. A composite element according to claim 2, wherein the inner layer of said multi-layer thermoplastic foil has a barrier functionality.

5. A composite element according to claim 2, wherein the outer layer of said multi-layer thermoplastic foil has an adhesion functionality.

6. A composite element according to claim 1, wherein the multi-layer thermoplastic foil is provided with at least three layers and in that the core is not dissoluble.

7. A composite element according to claim 6, wherein two outer layers of said multi-layer thermoplastic foil have a lower melting temperature than an intermediate layer.

8. A composite element according to claim 6, wherein the intermediate layer of said multi-layer thermoplastic foil has a barrier functionality.

9. A composite element according to claim 6, wherein each of the outer layers of said multi-layer thermoplastic foil have an adhesion functionality.

10. A composite element according to claim 1, wherein said multi-layer thermoplastic foil is co-extruded.

11. A method of making a composite element from a preform of fiber-reinforced plastic material with the following steps:
a) preparing the preform to a suitable shape by using a binder powder and/or by stitching its fabric,
b) wrapping the co-extruded multi-layer thermoplastic foil around the core with the outer layer with adhesive properties facing away from the core and the inner layer with a barrier functionality adjacent to the core;
c) attaching the preform of fiber-reinforced plastic material to the outer layer of the multi-layer thermoplastic foil;
d) applying resin to the preform and curing the composite element in a mould; and,
e) removing the dissoluble core by scavenging inside the composite element.

12. A method according to claim 11, wherein wrapping the co-extruded multi-layer thermoplastic foil around the core with the first outer layer with adhesive properties facing away from the core, the second outer layer with adhesive properties adjacent to the core and the inner, intermediate layer with a barrier functionality between the first outer layer and the second outer layer and maintaining the core inside the composite element after cure.
